(19) United States
(12) Patent Application Publication
(10) Pub. No.: US 2025/0022456 A1
(43) Pub. Date: Jan. 16, 2025

(54) MODEL TRAINING METHOD AND APPARATUS, ELECTRONIC DEVICE AND COMPUTER READABLE MEDIUM

(71) Applicant: MaShang Consumer Finance Co., Ltd., Chongqing (CN)

(72) Inventor: Qinglin MENG, Chongqing (CN)

(21) Appl. No.: 18/897,849

(22) Filed: Sep. 26, 2024

(30) Foreign Application Priority Data
Mar. 22, 2024 (CN) 202410334093.5

(51) Int. Cl. G10L 15/06; G10L 15/02; G10L 15/04

(52) U.S. Cl. CPC G10L 15/063; G10L 15/02; G10L 15/04

(57) ABSTRACT

The present disclosure provides a model training method, including: performing feature extraction from a speech sample to obtain a speech feature; inputting the speech feature into an encoding network of a to-be-trained model for encoding processing; decoding an intermediate encoding feature to obtain an additional loss; obtaining an encoding loss based on an encoding feature and an encoding label; obtaining a total encoding loss based on the additional loss, the encoding loss, and a preset first loss weight; inputting the encoding feature into a decoding network for decoding processing to obtain a total decoding loss; obtaining a total model loss based on the total encoding loss, the total decoding loss, and a preset second loss weight; updating parameters in the model based on the total model loss, and continuing to train the to-be-trained model according to the updated parameters until the total model loss converges, obtaining a trained model.

### CROSS-REFERENCE TO RELATED APPLICATIONS

This application claims priority to Chinese Patent Application No. 202410334093.5, filed on Mar. 22, 2024, which is hereby incorporated by reference in its entirety

### TECHNICAL FIELD

The present disclosure relates to the field of artificial intelligent and, in particular, to a model training method and apparatus, an electronic device and a computer readable medium.

### BACKGROUND

Speech recognition converts human speech content into text content, while end-to-end speech recognition uses neural network models instead of traditional alignment models, acoustic models, and language models to directly convert an audio sequence into a text sequence without requiring for pronunciation dictionaries and phoneme annotations.

A neural network-based speech recognition model includes an encoder and a decoder, where the encoder is responsible for mapping acoustic features and the decoder is responsible for modeling semantic information. The encoder uses a connectionist temporal classification (Connectionist Temporal Classification, CTC) loss for sequence alignment and loss calculation. The output feature of the encoder is input into the decoder, which uses a sequence loss for modeling. Due to a natural independence of CTC, modeling of the encoder cannot be based on the semantic information, resulting in lower performance of the encoder and lower accuracy of the speech recognition model. Moreover, in order to improve a generalization ability of the speech recognition model, there are multiple network layers in the speech recognition model, and an intermediate decoding layer cannot capture the semantic information either, thereby the accuracy of the speech recognition model is difficult to be improved.

### SUMMARY

The present disclosure provides a model training method and apparatus, an electronic device, and a computer-readable medium for improving model recognition accuracy.

In a first aspect, the present disclosure provides a model training method, including:
performing feature extraction from a speech sample to obtain a speech feature;
inputting the speech feature into an encoding network in a model, where the encoding network includes cascaded encoding layers, and the encoding layer includes a first encoding layer and a second encoding layer;
decoding a first encoding feature to obtain an additional loss, where the first encoding feature is an encoding feature output by the first encoding layer;
obtaining an encoding loss based on a second encoding feature output by the second encoding layer and an encoding label;
obtaining a total encoding loss based on the additional loss, the encoding loss, and a preset first loss weight;
inputting the second encoding feature output by the second encoding layer into a decoding network to obtain a total decoding loss;
obtaining a total model loss based on the total encoding loss, the total decoding loss, and a preset second loss weight;
updating parameters in the encoding network and the decoding network based on the total model loss, and training the model according to the updated parameters until the total model loss converges, obtaining a trained model.

In a second aspect, the present disclosure provides a speech recognition model, and the speech recognition model is a model obtained by means of the above model training method.

In a third aspect, the present disclosure provides a model training apparatus, including:
an extracting module, configured to perform feature extraction from a speech sample to obtain a speech feature;
an encoding module, configured to input the speech feature into an encoding network in a model, where the encoding network includes cascaded encoding layers, and the encoding layer includes a first encoding layer and a second encoding layer;
an additional module, configured to decode a first encoding feature to obtain an additional loss, where the first encoding feature is an encoding feature output by the first encoding layer;
a calculating module, configured to obtain an encoding loss based on a second encoding feature output by the second encoding layer and an encoding label, and obtain a total encoding loss based on the additional loss, the encoding loss, and a preset first loss weight;
a decoding module, configured to input the second encoding feature output by the second encoding layer into a decoding network to obtain a total decoding loss;
the calculating module is further configured to obtain a total model loss based on the total encoding loss, the total decoding loss, and a preset second loss weight;
an updating module, configured to update parameters in the encoding network and the decoding network based on the total model loss, and train the model according to the updated parameters until the total model loss converges, obtain a trained model.

In the fourth aspect, the present disclosure provides an electronic device, including: at least one processor; and a memory communicatively connected with the at least one processor; where, the memory stores one or more computer programs executed by the at least one processor, and the one or more computer programs are executed by the at least one processor to enable the at least one processor to perform the model training method described above.

In the fifth aspect, the present disclosure provides a computer-readable storage medium storing a computer program thereon, where the computer program, when executed by a processor, implements the model training method described above.

In the sixth aspect, the present disclosure provides a computer program product, including computer-readable codes or a non-volatile computer-readable storage medium carrying computer-readable codes, and when the computer-readable codes are executed in a processor of an electronic device, the processor of the electronic device executes the model training method described above.

In the model training method provided in embodiments of the present disclosure, an additional decoding network obtains a first encoding feature from a first encoding layer of an encoding network, decodes the first encoding feature to obtain an additional decoding feature; and obtains an additional loss based on the additional decoding feature and an additional label. Since the first encoding feature contains more semantic information, and the additional loss determined by the first encoding feature contains more semantic information, a total encoding loss determined based on the additional loss, the encoding loss, and a preset first loss weight contains more semantic information, and a total model loss obtained by combining the total encoding loss with a total decoding loss also contains semantic information. Therefore, a parameter of a to-be-trained speech recognition model is updated based on the total model loss until the total model loss converges, which enables the trained speech recognition model to obtain more semantic information, thereby improving accuracy of the speech recognition model.

It should be understood that, content described in this section is not intended to identify key or important features of the embodiments of the present disclosure, nor is intended to limit a scope of the present disclosure. Other features of the present disclosure will be easily understood through the following specification.

### BRIEF DESCRIPTION OF DRAWINGS

Accompanying drawings are used to provide further understanding of the present disclosure and form a part of the specification. They are used together with embodiments of the present disclosure to explain the present disclosure and do not constitute limitations on the present disclosure. By referring to the accompanying drawings to describe detailed example embodiments, the above and other features and advantages will become more apparent to those skilled in the art. In the accompanying drawings:

FIG. 1 is a structural diagram of a speech recognition model in an embodiment of the present disclosure.

FIG. 2 is a model training structural diagram for training a speech recognition model in an embodiment of the present disclosure.

FIG. 3 is a flowchart diagram of a model training method provided by an embodiment of the present disclosure.

FIG. 4 is a structural diagram of an encoding layer provided by an embodiment of the present disclosure.

FIG. 5 is a block diagram of an intelligent speech system provided by an embodiment of the present disclosure.

FIG. 6 is a block diagram of a model training apparatus provided by an embodiment of the present disclosure.

FIG. 7 is a block diagram of an electronic device provided by an embodiment of the present disclosure.

### DESCRIPTION OF EMBODIMENTS

In order to enable those skilled in the art to better understand technical solutions disclosed in the present disclosure, the following exemplary embodiments of the present disclosure are explained in conjunction with accompanying drawings, which include various details of the embodiment of the present disclosure to facilitate understanding, and they should be considered merely exemplary. Therefore, those skilled in the art should recognize that various changes and modifications can be made to the embodiments described herein without departing from scope and spirit of the present disclosure. Similarly, for clarity and conciseness, descriptions of well-known functions and structures have been omitted in the following description.

In an absence of conflicts, various embodiments disclosed herein and the features therein may be combined with each other.

As used in this article, a term “and/or” includes any and all combinations of one or more related listed items.

The terms used in this article are only intended to describe specific embodiments and are not intended to limit the present disclosure. As used in this article, singular forms of “a” and “the” are also intended to include plural forms, unless context clearly indicates otherwise. It will also be understood that, when the terms “include” and/or “made of” are used in this specification, a presence of features, entireties, steps, operations, elements, and/or components is specified, but it does not exclude the presence or an addition of one or more other features, entireties, steps, operations, elements, components, and/or groups thereof. Words like “connection” or “coupling” are not limited to physical or mechanical connections, but can include electrical connections, whether direct or indirect.

Unless otherwise specified, all terms used in this article (including technical and scientific terms) have the same meanings as those commonly understood by those skilled in the art. It will also be understood that, the terms such as those defined in commonly used dictionaries should be interpreted as having a meaning consistent with their meaning under the context of relevant technologies and a background of the present disclosure, and will not be interpreted as having an idealized or overly formal meaning, unless explicitly so limited in this article.

CTC loss can be applied to an end-to-end speech recognition model, and used for recognizing streaming speech, and directly converting a speech sequence into a label sequence. However, CTC has independence, which makes it impossible for an encoding network to model according to semantic information. Although the decoding network can enable an output of a last layer of an encoding network to have certain semantic information modeling capability, due to a large number of encoding layers in the encoding network, the semantic information captured by the last layer is very limited, which cannot improve accuracy of the speech recognition model.

A model training method and apparatus, an electronic device, and a readable medium provided in embodiments of the present disclosure can be executed by an electronic device such as a terminal device or a server, and the terminal device can be a vehicle mounted device, a user equipment (UE), a mobile device, a user terminal, a terminal, a cellular phone, a cordless phone, a personal digital assistants (PDA), a handheld device, a computing device, a wearable device and the like. The method can be implemented by a processor calling computer-readable program instructions stored in a memory. Alternatively, the method can be executed through the server.

In the present disclosure, unless otherwise specified, the following technical terms should be interpreted and understood as follows:
transformer model: a temporal model based on a self-attention mechanism, the encoding network can effectively encode temporal information, and a processing ability for the temporal information is better than that of a long short-term memory (LSTM) network. It has a strong parallel-computing ability and a fast operation speed, and is widely used in fields such as natural language processing, computer vision, machine translation, and speech recognition. Conformer model: it combines the Transformer model with a convolutional neural network (CNN). The Transformer model is good at capturing content-based global interactions, while the CNN can effectively utilize local features, making the Conformer model have a good modeling ability for both long-term global interaction information and the local feature.

CTC model: adding a classification layer to the last layer of a recurrent neural network (RNN) for predicting sequence labels. Traditional sequence labeling algorithms require complete alignment of input and output symbols at every moment, while CTC extends a label set by adding empty elements. After using the extended label set to label the sequence, all predicted sequences that can be converted into real sequences through mapping functions are correct prediction results, which means that there is no need to align data to obtain the predicted sequence.

In a first aspect, an embodiment of the present disclosure provides a model training method, and a model trained by this training method has higher accuracy. The embodiment of the present disclosure does not limit the model, for example, the model may be a speech recognition model.

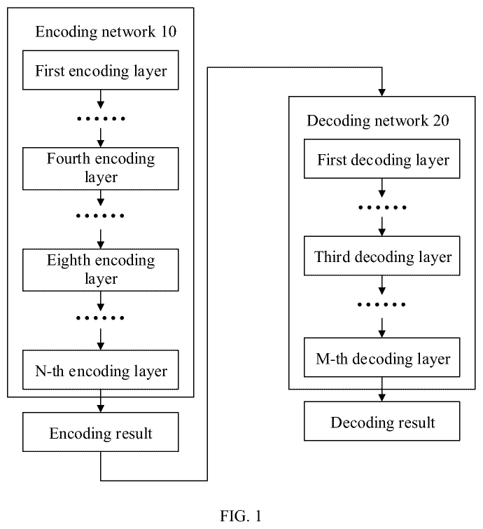

FIG. 1 is a structural diagram of the model in the embodiment of the present disclosure. As shown in FIG. 1, the model includes an encoding network 10 and a decoding network 20, where the encoding network 10 includes cascaded N-layer encoding layers, and the encoding layers include an intermediate encoding layer and an N-th encoding layer. The decoding network 20 includes cascaded M-layer decoding layers, and the decoding layers include an intermediate decoding layer and an M-th decoding layer, where N and M are integers greater than or equal to 2. The embodiment of the present disclosure does not limit the number of layers of the encoding layers in the encoding network 10, for example, the number of layers of the encoding layers is 12. The encoding layer can use a residual attention mechanism for encoding.

The embodiment of the present disclosure does not limit the number of layers of the decoding layers in the decoding network 20, for example, the number of layers of the decoding layers is 6. The embodiment of the present disclosure does not limit the type of decoders used in the decoding layer. For example, the decoder can use a transform decoder, and the decoder uses words as calculation targets.

When using the model for speech recognition, a to-be-recognized speech is input into the model, and the to-be-recognized speech is passed through the encoding network 10 and decoding network 20 to output a recognition result.

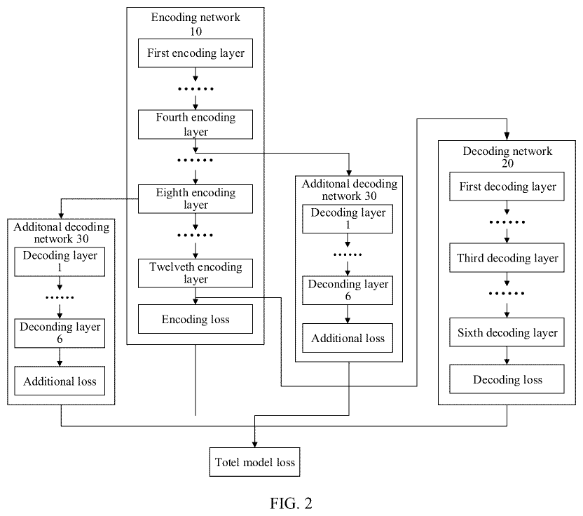

FIG. 2 is a model training structural diagram provided by an embodiment of the present disclosure. As shown in FIG. 2, a model training structure includes an encoding network 10, a decoding network 20, and an additional decoding network 30. The encoding network 10 and the decoding network 20 are the same as the encoding network 10 and the decoding network 20 in FIG. 1, and will not be repeated here. The additional decoding network 30 includes cascaded L-layer decoding layers, where L is an integer greater than or equal to 1. The embodiment of the present disclosure does not limit the number of decoding layers in the additional decoding network 30, for example, the number of decoding layers can be 6.

An input of the additional decoding network 30 comes from an intermediate encoding feature output by an intermediate encoding layer of the encoding network 10. The additional decoding network 30 processes the intermediate encoding feature to obtain an additional decoding feature, and obtains an additional loss based on the additional decoding feature and additional labels. Since the additional loss is determined based on the additional decoding feature, and the additional decoding feature is obtained based on the intermediate encoding feature of the encoding network 10, the intermediate encoding features contain more semantic information, enabling the additional decoding feature to capture more semantic information. Therefore, model parameters determined based on the additional loss are more accurate.

In the model training structure, the number of additional decoding networks 30 can be one or multiple. When the model training structure includes multiple additional decoding networks 30, the number of decoding layers in each additional decoding network 30 can be the same or different.

The input of different additional decoding networks 30 comes from different encoding layers in the encoding network 10, that is, each additional decoding network 30 processes the intermediate encoding features output by different encoding layers to capture semantic information in different encoding layers, thereby making the model parameters more accurate.

When the model training structure includes one additional decoding network 30, the additional decoding network 30 can process any intermediate encoding feature in the encoding network 10, for example, it can process the intermediate encoding feature at one-half, the intermediate encoding feature at one-third, or the intermediate encoding feature at two-thirds of the encoding network 10.

When the model training structure includes two additional decoding networks 30, the two additional decoding networks 30 can respectively process the intermediate encoding feature at one-third and the intermediate encoding feature at two-thirds of the encoding network 10. For example, when the encoding network 10 includes 12 layers of encoding layers, one additional decoding network 30 processes the intermediate encoding feature output by the 4th encoding layer in the encoding network 10, and another additional decoding network 30 processes the intermediate encoding feature output by the 8th encoding layer in the encoding network 10.

The model training method provided in the embodiment of the present disclosure is trained in the model training structure shown in FIG. 2, but when using a trained model, the additional decoding network is removed, and only the encoding network 10 and decoding network 20 are retained.

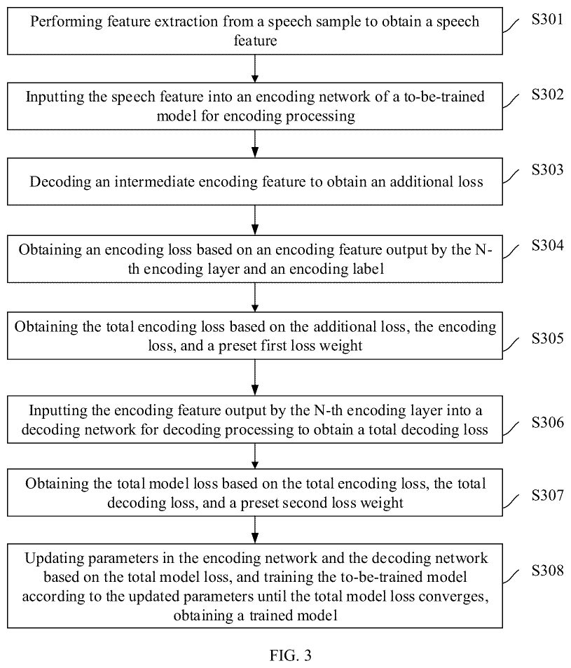

FIG. 3 is a flowchart diagram of a model training method provided by an embodiment of the present disclosure. Referring to FIG. 3, the model training method includes: Step S301: performing feature extraction from a speech sample to obtain a speech feature.

Where, the speech sample can be a conversation speech between a customer and an agent in a customer service system. For example, taking the conversation speech that nearly 50000 hours in the customer service system as an initial sample, processing the initial sample, removing invalid initial samples, and obtaining the speech sample. The invalid initial sample includes an invalid speech with short speaking time and no substantial content. For example, conversation speech that is less than 5 seconds can be removed.

Before performing the feature extraction from the speech sample, the speech sample can also be indexed to obtain a corresponding text, and text data can be annotated to obtain a sample label.

In some embodiments, the speech feature is an fbank feature, and the step of performing the feature extraction from the speech sample to obtain the fbank feature includes pre-emphasis, framing, windowing, discrete Fourier transform, and Mel filtering processing.

Pre-emphasis: air is a carrier of a speech signal and can propagate and dissipate energy of a sound wave. When a size of a sound source is constant, the higher the frequency is, the greater the loss is. The pre-emphasis can compensate for a high-frequency component loss and enhance a high-frequency component of the signal.

The embodiment of the present disclosure uses a high-pass filter for pre-emphasis processing, that is, the high-pass filter controls a degree of passing of high-frequency information in the speech sample, enhances the high-frequency component, and enables the entire frequency band from low-frequency to high-frequency to use the same signal-to-noise ratio to calculate a spectrum. The high-frequency information contains a lot of linguistic information, which can enable the model to obtain more linguistic information during subsequent information fusion processing, thereby improving the accuracy of the model. A working principle of the high pass filter is: O(n)=k*x(n)−m*x(n−1)
where, O(n) represents a result after a high-pass filtering, n represents a sampling point, x represents the speech sample, k and m represent filtering coefficients, k represents a preserve capacity for the high-frequency information, and m represents a suppression capability for the high-frequency information. The larger k and the smaller m, the weaker the suppression capability of the high-pass filter on the high-frequency information.

Framing: in order to obtain fine-grained features for a subsequent co-use of language information and acoustic information. In the embodiment of the present disclosure, a value of the audio sampling point N after the framing is set to 256, which includes a time of about 20 ms, at the same time, to avoid an excessive spacing between adjacent frames, which may result in insufficient granularity of extracted features when modeling with speech and emotion recognition jointly; moreover, there is an overlapping area between the adjacent frames, and the overlapping area contains 128 audio sampling points. Through this framing scheme, an information confusion caused by a subsequent attention score matrix because of insufficient capturing of the feature granularity can be alleviated, thereby improving an information stability when merging by the attention score matrix.

Windowing: the framing is essentially a discrete representation for the speech sample, such discrete representation needs to express continuous information as much as possible to reduce a spectral leakage of extracted speech features. In a deep fusion of the language information and acoustic information, if there is the spectral leakage, significant errors will occur in a judgment of the language information, affecting a final representation of the acoustic information. Therefore, continuous information of a speech frame is required to ensure the accuracy of the model.

Therefore, after framing the speech sample, it is necessary to perform a windowing operation for each speech frame to increase a continuity of a left end and a right end of the frame, reduce the spectral leakage, and ensure that the two ends of the window do not change sharply and smoothly transition to 0, thereby enabling truncated speech frame to slowly reduce to 0 and reducing a truncation effect of the speech frame.

The embodiment of the present disclosure performs the windowing operation through a window function, and an expression of the window function is Formula (1):

$$K ( n ) = 0.66 - 0.24 * \sqrt{( 1 - sin {( \frac{2 π n}{N - 1} )}^{2} )} \qquad ( 1 )$$

in Formula (1), N represents the number of sampling points, n represents the sampling point, and K(n) represents a result of the sampling point after windowing. The windowing function can make the discrete information of each speech frame to be correlated backwards and forwards, because a sin function that limits a weight establishes a functional relationship between each speech frame through a specific weighted manner, which can enable the additional decoding network to enhance a semantic information capability of the decoding network; and when the attention score matrix in an encoding network is merging, it can continuously represent the backward and forward discrete information of the speech frame, avoiding the spectral leakage and improving the accuracy of the model.

Fourier transform: speech characteristics can be better observed from a frequency-domain energy distribution. After performing the Fourier transform on each speech frame, a spectral signal is obtained, that is, the spectral signal of each speech frame in the frequency domain is obtained.

Mel filtering: the spectral signal is filtered through a Mel filter bank, a mapping relationship between a human ear perception for a real audio feature and a discrete signal is established by means of passband and stopband characteristics of different Mel filters in different frequency ranges, thereby mapping the spectrum to a Mel nonlinear spectrum that conforms to the human ear perception.

The Mel filter in the embodiment of the present disclosure is implemented through a group of rectangular filters with adjustable coefficients, with a center frequency of f(m)=1, 2, 3 . . . . P, and the value of P can be 22. The rectangular filter can preserve original information as much as possible in low amplitude component, and transform high amplitude components into an information representation that conforms to the human ear, thereby making the feature more in line with a prediction requirement of the additional decoding network mentioned above, and meet a low amplitude acoustic information requirement when performing information merging between attention score matrices.

The fine-grained speech feature is obtained through step S301, and this speech feature can help the additional decoding networks to obtain more semantic information subsequently, resulting in higher accuracy of a trained model.

In some embodiments, before performing the feature extraction from the speech sample to obtain the speech feature, it includes: obtaining the speech sample, segmenting the speech sample to obtain speech segments; annotating the speech segment that belongs to a noise to obtain a noise label; performing the feature extraction from the speech segment that does not belong to the noise to obtain the speech feature.

Where, the noise includes the speech segment that contains a sound but cannot recognize specific words. The noise is labelled as an unknownword (UNK) label, and the mute speech segment is labelled as a blank (blank) label. The model thus trained can avoid learning both the UNK label and blank label as the blank label, thereby improving an anti-noise capability of the model.

The speech sample is segmented into several speech segments, each with a length between 0.8-2.0 s. Then, the speech segment is recognized, and the speech segment that belongs to the noise is labelled to obtain the noise label, and the feature extraction is performed from the speech segment that does not belong to the noise to obtain the speech feature.

In the present disclosure, the speech sample is segmented into the speech segment of 0.8-2.0 s, which can identify the noise and annotate it, enabling the model to have a noise recognition capability and improve the anti-noise capability of the model.

Step S302, inputting the speech feature into an encoding network of a to-be-trained model for encoding processing.

Where, the encoding network includes cascaded N-layer encoding layers, N is an integer greater than or equal to 2. The encoding layers include an intermediate encoding layer and an N-th encoding layer, both of which can use encoders in the field of deep learning to map the input speech feature to a low dimensional vector. In some embodiments, the encoding layer adopts a residual attention module, which is an improved version of a multi-head attention mechanism.

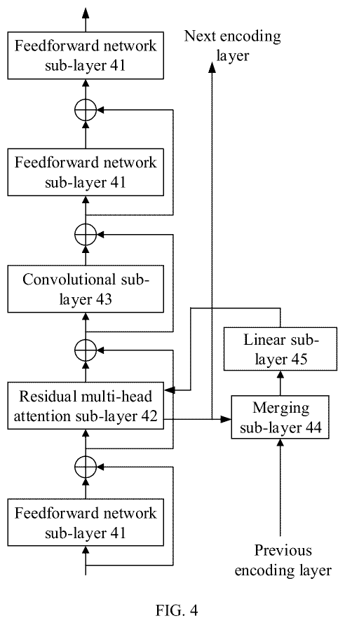

FIG. 4 is a structural diagram of an encoding layer provided by an embodiment of the present disclosure. As shown in FIG. 4, the encoding layer includes a feedforward network sub-layer 41, a residual multi-head attention sub-layer 42, and a convolutional sub-layer 43, all of which use residual structures.

Where, the feedforward network sub-layer 41 can use a feedforward network in the field of deep learning to extract a feature, while the convolutional sub-layer 43 can extract a speech feature through a convolution operation. The embodiment of the present disclosure does not limit structures of the feedforward network sub-layer and convolutional sub-layer.

The residual multi-head attention sub-layer 42 merges information of a current encoding layer with the information of a previous encoding layer to obtain a mutual attention relationship between a certain word and other words, that is, to achieve the mutual attention relationship of different levels, which can improve a dynamic attention range of the current encoding layer, and then the merged information is inputted into a next encoding layer. Where, the previous encoding layer refers to the last encoding layer adjacent to the current encoding layer, and the next encoding layer refers to the latter encoding layer adjacent to the current encoding layer.

In some embodiments, the 2nd to N-th encoding layers in the encoding network perform the following steps:

obtaining a score matrix of a previous layer based on a query matrix and a key value matrix in the previous encoding layer; obtaining the score matrix of a current layer based on the query matrix and the key value matrix in the current encoding layer; merging the score matrix of the previous layer and the score matrix of the current layer to obtain an encoding feature, and inputting the encoding feature into a next encoding layer; the encoding feature is an encoding feature after merging the features of the current encoding layer and the previous encoding layer, that is, the encoding feature is the encoding feature that merges information from different layers.

Where, the query matrix and key value matrix are matrices in a self-attention mechanism, and the present disclosure does not limit specific acquisition methods of the query matrix and key value matrix. For example, the query matrix Q is obtained through a calculation of a linear transformation matrix WQ according to the input speech feature or an output of the previous encoding layer, and the key value matrix K is obtained through the calculation of a linear transformation matrix WK according to the input speech feature or the output of the previous encoding layer.

After performing a multiplication operation on the query matrix Q and key value matrix K in any encoding layer, a softmax operation is performed to calculate an attention coefficient of each word for other words, and the score matrix of that encoding layer is obtained.

For example, the current encoding layer obtains the query matrix Q and key value matrix K from the previous encoding layer, performs the multiplication operation on the query matrix Q and key value matrix K of the previous encoding layer, and performs a softmax (softmax) operation on a multiplication result to obtain the score matrix of the previous layer; at the same time, the multiplication operation is performed on the query matrix Q and the key value matrix K in the current encoding layer, and the softmax operation is performed on the multiplication result to obtain the score matrix of the current layer. Then, the score matrix of the previous layer and the score matrix of the current layer are input into a merging sub-layer 44 for merging, and a merged result is input into a linear sub-layer 45 to achieve the merging of attention information in different layers. Finally, the merged encoding feature is sent to the next encoding layer. Where, the merging of the score matrix of the previous layer and the score matrix of the current layer can be a matrix addition operation.

It should be noted that, for the N-th encoding layer, after obtaining the merged information, it will no longer be inputted to the next encoding layer, but is used as an output result of the encoding network to calculate an encoding loss.

The encoding layer provided in the embodiment of the present disclosure adopts information merging technology, in order to merge the attention information of different encoding layers, which can improve range and capability of the model to capture information and enhance the accuracy of the model.

Step S303, decoding an intermediate encoding feature to obtain an additional loss.

Where, the intermediate encoding feature is the encoding feature output by the intermediate encoding layer. For example, when the encoding network includes 12 encoding layers, the intermediate encoding feature is the encoding feature output by any one of the 1st to 11th encoding layers. And an additional label can be a label that pre-labeled through manual or other means.

In some embodiments, the intermediate encoding feature includes the intermediate encoding feature at one-third of the encoding network, and/or the intermediate encoding feature at two-thirds of the encoding network. For example, when the encoding network includes 12 encoding layers, the intermediate encoding feature can be the intermediate encoding feature output by the 4th encoding layer and/or the intermediate encoding feature output by the 8th encoding layer. By selecting the intermediate encoding feature at one-third and/or two-thirds as the input for the additional decoding network, the additional loss can be calculated from semantic information at different levels. Based on the additional loss, a total encoding loss can be calculated, and thereby determining a total model loss; that is, the total model loss includes the additional loss, and a model parameter thus adjusted can make the total model loss converge more quickly.

In some embodiments, decoding the intermediate encoding feature to obtain the additional loss includes: decoding the intermediate encoding feature to obtain an additional decoding feature, and obtaining the additional loss based on the additional decoding feature and a preset additional decoding label.

The intermediate encoding feature is inputted into the additional decoding network for decoding processing, so as to obtain the additional decoding feature, where the additional decoding network includes cascaded K-layer decoding layer, and K is an integer greater than or equal to 1. Where, the decoding layer can use a transformer decoder or other decoders. The intermediate encoding feature is decoded using the K-layer decoding layer to obtain the additional decoding feature, and then the additional decoding network obtains the additional loss through the additional decoding feature and the additional label.

In some embodiments, the additional loss L_{add-middle} can be obtained through Formula (2):

$${L}_{add - middle} = - log P ( y / {x}_{( k / 3 )} ) \qquad ( 2 )$$

in Formula (2), L_{add-middle} represents the additional loss, P represents an attention distribution probability, y represents the additional label, x represents an input, k/3 represents the intermediate encoding layer, and k represents the number of layers in the encoding layer.

For example, if the input of the additional decoding network is the output of the fourth encoding layer in the encoding network; that is, x is the output of the fourth encoding layer in the encoding network as the input of the additional decoding network, and the additional label y is the additional label that pre-labeled, the additional loss L_{add-middle} can be obtained through Formula (2).

It should be noted that, when the model training method sets multiple additional decoding networks, each additional decoding network obtains one additional loss; at this time, the additional loss can be a sum of the additional losses of respective additional decoding networks. For example, when the model training method sets a first additional decoding network and a second additional decoding network, the input of the first additional decoding network can be the output of the fourth encoding layer, and the input of the second additional decoding network can be the output of the eighth encoding layer. A first additional loss is obtained through the first additional decoding network, and a second additional loss is obtained through the second additional decoding network, then the additional loss is the sum of the first additional loss and the second additional loss.

Step S304, obtaining an encoding loss based on an encoding feature output by the N-th encoding layer and an encoding label.

Where, the output of the N-th encoding layer is the output of the encoding network, that is, the encoding feature output by the N-th encoding layer is the encoding feature output by the encoding network, and the speech feature is encoded layer by layer by the N-layer encoding layers in the encoding network to output the encoding feature.

The encoding label in this embodiment can be pre-labeled manually. And the encoding loss is obtained based on the encoding feature outputted by the encoding network and the encoding label.

In some embodiments, the encoding loss is calculated using Formula (3).

$${L}_{ctc} = {\sum }_{ε ∈ {δ}^{- 1} ( l )} log P ( ε \vert {y}_{enc} ) \qquad ( 3 )$$

in Formula (3), L_{ctc} represents the encoding loss, l represents a label sequence, l=(l₁ . . . lᵣ), r represents the length, P represents the attention distribution probability, δ( ) represents a multiple-to-one mapping, which is used to remove blank and duplicate output generated during an alignment, ε represents the encoding label, and y_{enc} represents the input.

In some embodiments, the encoding loss can be calculated through a backtracking algorithm, which can effectively obtain all sequence solutions and then obtain the optimal solution from all of the sequence solutions. Therefore, using a backtracking algorithm for the encoding loss can improve the accuracy of the model.

Step S305, obtaining the total encoding loss based on the additional loss, the encoding loss, and a preset first loss weight.

Where, the first loss weight is pre-set.

In some embodiments, the total encoding loss is calculated using Formula (4).

$${L}_{enc \_ total} = ( 1 - q ) * {L}_{ctc} + q * {L}_{add - middle} \qquad ( 4 )$$

in Formula (4), L_{enc_total} represents the total encoding loss, L_{ctc} represents the encoding loss, L_{add-middle} represents the additional loss, and q represents the first weight.

Step S306, inputting the encoding feature output by the N-th encoding layer into a decoding network for decoding processing to obtain a total decoding loss.

Where, the decoding network includes cascaded M-layer decoding layers, and the decoding layers contain an intermediate decoding layer and an M-th decoding layer, where M is an integer greater than or equal to 2.

The encoding feature outputted by the last layer of the encoding network is inputted into the decoding network, that is, the encoding feature output by the N-th encoding layer is inputted into the decoding network, the encoding feature is decoded by using the decoding network to obtain the decoding feature, and the total decoding loss is then obtained based on the decoding feature.

In some embodiments, the inputting the encoding feature output by the N-th encoding layer into the decoding network for decoding processing to obtain the total decoding loss, includes: obtaining an intermediate loss based on the decoding feature output by the intermediate decoding layer and an intermediate decoding label, where the decoding network includes the intermediate decoding layer and the M-th decoding layer; obtaining the decoding loss based on the decoding feature output by the M-th decoding layer and the decoding label; and obtaining the total decoding loss based on the intermediate loss, the decoding loss, and a preset third loss weight.

Where, the intermediate decoding label and the decoding label are pre-labeled, and this embodiment does not limit a labeling manner. For example, a manual annotation can be used for the annotation. The third loss weight is pre-set and can also be determined according to experiments, for example, the third loss weight can be 0.7.

In some embodiments, the total decoding loss can be calculated using Formula (5).

$${L}_{ATT \_ total} = β * {L}_{ATT} + ( 1 - β ) * {L}_{ATT \_ middle} \qquad ( 5 )$$

in Formula (5), L_{ATT_total} represents the total decoding loss, L_{ATT} represents the decoding loss, L_{ATT} middle represents the intermediate loss, and β represents the third loss weight.

For example, as shown in FIG. 2, the decoding network includes 6 layers of decoding layers, with the third layer being the intermediate decoding layer. The intermediate loss L_{ATT_middle} is obtained based on the output of the third decoding layer and the intermediate decoding label. The decoding loss L_{ATT} is obtained based on the decoding feature output by the M-th decoding layer and the decoding label, and then the total decoding loss L_{ATT} total is obtained based on the intermediate loss, the decoding loss, and the preset third loss weight.

Step S307, obtaining the total model loss based on the total encoding loss, the total decoding loss, and a preset second loss weight.

Where, the second loss weight is pre-set, and a user can set it arbitrarily according to an actual training situation.

In some embodiments, the total model loss is calculated using Formula (6).

$${L}_{total} = α * {L}_{enc \_ tatal} + {( 1 - α )}^{*} {L}_{ATT \_ total} \qquad ( 6 )$$

in Formula (6), Lₜₒₜₐₗ represents the total model loss, L_{enc_tatal} represents the total encoding loss, L_{ATT_total} represents the total decoding loss, and a represents the second loss weight.

Step S308, updating parameters in the encoding network and the decoding network based on the total model loss, and training the to-be-trained model according to the updated parameters, until the total model loss converges, obtaining a trained model.

The parameters in the encoding and decoding networks are adjusted according to the total model loss. After the parameters are adjusted, the model is trained continuously using the speech sample according to the updated parameters until the total model loss converges, and the trained model is obtained.

In some embodiments, updating the parameters in the encoding network and decoding network based on the total model loss, includes: updating the parameters in the encoding network and the decoding network based on the total model loss and a regularization term.

During a model training process, a parameter update stage and a gradient update stage in the encoding network and decoding network are updated according to the total model loss. In the parameter update stage, the regularization term is added to update the parameters in the encoding and decoding networks, which improves a convergence speed and a generalization capability of the model. However, in the gradient update stage, no regularization term is added to update the parameters in the encoding network and decoding network, which can avoid a severe parameter oscillation caused by a gradient accumulation, thus achieving a fast and accurate minimization of a loss function, improving a training effect and the generalization capability of the model.

In some embodiments, a learning rate is adaptively optimized using an Adam (Adaptive Moment Estimation) optimizer. The regularization term can be an L2 regularization term.

Update rules for the Adam optimizer are as follows:

$${m}_{t} = {β}_{1} {m}_{t - 1} + ( 1 - {β}_{1} ) {g}_{t}$$

$${v}_{t} = {β}_{2} {v}_{t - 1} + ( 1 - {β}_{2} ) {g}_{t}^{2}$$

$${\hat{m}}_{t} = \frac{{m}_{t}}{1 - {β}_{1}^{t}}$$

$${\hat{v}}_{t} = \frac{{v}_{t}}{1 - {β}_{2}^{t}}$$

$${θ}_{t + 1} = {θ}_{t} - \frac{η}{\sqrt{{\hat{v}}_{t} + ε}} {\hat{m}}_{t}$$

where, mₜ represents a first-order momentum, vₜ represents a second-order momentum, β₁ and β₂ represent attenuation coefficients, gₜ represents a parameter gradient, \hat{m}ₜ and \hat{v}ₜ represent moving average after a deviation correction, θₜ₊₁ represents an updated parameter, θₜ represents a parameter before update, η represents a learning rate, and ε represents a constant.

In some embodiments, before the intermediate encoding feature is input into the additional decoding network for decoding, it further includes: obtaining a first total encoding loss based on the encoding feature output by the N-th encoding layer and the encoding label; inputting the encoding feature output by the N-th encoding layer into the decoding network for decoding processing to obtain a first total decoding loss, where the decoding network includes cascaded M-layer decoding layers, and M is an integer greater than or equal to 2; obtaining a first total model loss based on the first total encoding loss, the first total decoding loss and a preset second loss weight; and updating the parameters in the encoding network and decoding network based on the first total model loss, and training the to-be-trained model according to the updated parameters until a preset condition is reached and a pre-trained model is obtained; using parameters of the pre-trained model as initial parameters for the encoding network and the decoding network.

In a pre-training stage, there is no need to calculate the additional losses. The speech feature is encoded by means of the encoding network to obtain the encoded feature, the first encoding loss is then obtained by means of the encoding feature and the encoding label; that is, the first encoding loss is obtained based on the decoding feature output by the N-th encoding layer and the decoding label, and this first encoding loss is used as the first total encoding loss. The first total decoding loss is obtained in the same way as in step 306, and then the first total model loss is obtained based on the first total encoding loss, the first total decoding loss and the preset second loss weight, and the parameters in the encoding network and the decoding network are updated based on the first total model loss, and the to-be-trained model is continued to be trained until the preset condition is met and the pre-trained model is obtained.

After the pre-trained model is obtained, a network parameter in the decoding network is assigned to the additional decoding network, and then the pre-trained model is further trained. During a further training process, the additional decoding network is used to decode the intermediate encoding feature to obtain the additional loss. Then, steps S304 to S308 are executed until the trained model is obtained.

In the model training method provided in the embodiment of the present disclosure, the additional decoding network obtains the intermediate encoding feature from the intermediate encoding layer of the encoding network, decodes the intermediate encoding feature to obtain the additional decoding feature, and obtains the additional loss based on the additional decoding feature and the additional label. Since the intermediate encoding feature contains more semantic information, the additional loss that determined by the intermediate encoding feature contains more the semantic information. The total encoding loss determined based on the additional loss, the encoding loss, and the preset first loss weight thus contains more semantic information, and the total model loss obtained by combining the total encoding loss and total decoding loss also contains the semantic information. Therefore, the parameter of the to-be-trained model is updated based on the total model loss until the total model loss converges, enabling the trained model to obtain more semantic information, thereby improving the accuracy of the model.

In a second aspect, an embodiment of the present disclosure provides a speech recognition model, which is a model obtained through the model training method provided by the embodiment of the present disclosure. The model training method will not be elaborated.

When using this speech recognition model, a to-be-recognized speech can be input into the speech recognition model and encoded through an encoding network to obtain an encoding feature; the encoding feature is decoded through a decoding network to obtain a speech recognition result.

Due to a fact that the speech recognition model is the model obtained through the model training method provided by the embodiment of the present disclosure, more semantic information is obtained during a training process, resulting in more accurate results for speech recognition by this speech recognition model.

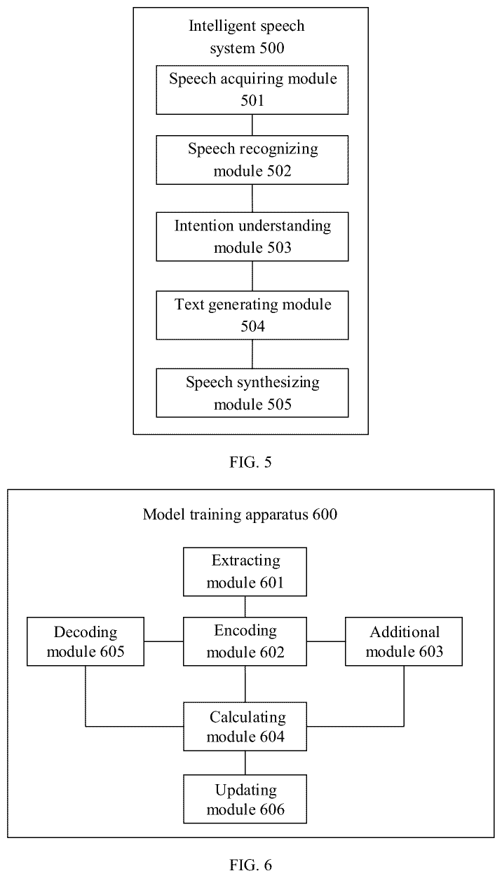

FIG. 5 is a block diagram of an intelligent speech system provided in embodiment of the present disclosure. The intelligent speech system can be a system used by intelligent customer service system or intelligent sales system.

As shown in FIG. 5, the intelligent speech system 500 includes a speech acquiring module 501, a speech recognizing module 502, an intention understanding module 503, a text generating module 504, and a speech synthesizing module 505.

The speech acquiring module 501 is configured to collect a speech, and the collected speech can be a speech stream signal inputted from a telephone user end in real time.

The speech recognizing module 502 can use a model trained by the model training method provided by the embodiment of the present disclosure to perform the speech recognition on the collected speech, and perform feature extraction, encoding, and decoding steps through the model, in order to obtain the decoding result.

The intention understanding module 503 is configured to judge an intention of the decoding result and obtain the intention corresponding to the speech stream signal.

The text generating module 504 is configured to obtain a corresponding reply based on the intention and a judgment logic, and obtain a response text.

The speech synthesizing module 505 is configured to perform a speech synthesis correspondingly to the response text, and obtain a response speech.

If there are multiple rounds of dialogue, speech stream information of any one round is passed through the speech recognizing module 502, intention understanding module 503, text generating module 504, and speech synthesizing module 505 to generate a corresponding response speech, and this process repeats to achieve intelligent response.

In a third aspect, an embodiment of the present disclosure provides a model training apparatus.

FIG. 6 is a block diagram of the model training apparatus provided by the embodiment of the present disclosure. As shown in FIG. 6, the model training apparatus 600 includes:

an extracting module 601, configured to perform feature extraction from a speech sample and obtain a speech feature.

An encoding module 602, configured to input the speech feature into an encoding network of a to-be-trained model for encoding processing, where the encoding network includes cascaded encoding layers, and the encoding layer includes an intermediate encoding layer and an N-th encoding layer.

An additional module 603, configured to decode an intermediate encoding feature to obtain an additional loss; where the intermediate encoding feature is an encoding feature output by the intermediate encoding layer.

A calculating module 604, configured to obtain an encoding loss based on an encoding feature output by the N-th encoding layer and an encoding label; and obtain a total encoding loss based on the additional loss, the encoding loss, and a preset first loss weight.

The decoding module 605 is configured to input the encoding feature output by the N-th encoding layer into a decoding network for decoding processing to obtain a total decoding loss.

The calculating module 604 is further configured to obtain a total model loss based on the total encoding loss, the total decoding loss, and a preset second loss weight.

An updating module 606, configured to update parameters in the encoding network and the decoding network based on the total model loss, train the to-be-trained model according to the updated parameters until the total model loss converges, and obtain a trained model.

In some embodiments, the additional module 603 is configured to decode the intermediate encoding feature and obtain an additional decoding feature; and obtain the additional loss based on the additional decoding feature and a preset additional decoding label.

In some embodiments, the intermediate encoding feature includes the intermediate encoding feature at one-third of the encoding network, and/or the intermediate encoding feature at two-thirds of the encoding network.

In some embodiments, the decoding module 605 is further configured to input the encoding feature output by the N-th encoding layer in the decoding network for decoding processing; obtain the intermediate loss based on the decoding feature output by the intermediate decoding layer and an intermediate decoding label, where the intermediate decoding layer is the decoding layer in the decoding network except for the M-th layer; obtain the decoding loss based on the decoding feature output by the M-th decoding layer and a decoding label; and obtain the total decoding loss based on the intermediate loss, the decoding loss, and a preset third loss weight.

In some embodiments, the encoding module 602 is further configured to obtain a score matrix of a previous layer based on a query matrix and a key value matrix in the previous encoding layer; obtain the score matrix of a current layer based on the query matrix and the key value matrix in a current encoding layer; merge the score matrix of previous layer with the score matrix of current layer to obtain the encoding feature, and input the encoding feature into a next encoding layer.

In some embodiments, it also includes a pre-trained model, configured to input the speech feature into the to-be-trained model, perform a pre-training on the to-be-trained model, and obtain initial parameters of the encoding network and the decoding network.

In some embodiments, the updating module 606 is further configured to update the parameters in the encoding network and the decoding network based on the total model loss and a regularization term during a parameter update phase.

In some embodiments, the extracting module 601 is further configured to obtain the speech sample and segment the speech sample to obtain speech segments; and annotate the speech segment that belongs to noise and obtain a noise label.

In the model training apparatus provided in embodiment of the present disclosure, the additional decoding network obtains the intermediate encoding feature from the intermediate encoding layer of the encoding network, decodes the intermediate encoding feature to obtain the additional decoding feature, and obtains the additional loss based on the additional decoding feature and the additional label. Since the intermediate encoding feature contains more semantic information, and the additional loss determined by the intermediate encoding feature contains more semantic information, the total encoding loss determined based on the additional loss, the encoding loss, and the preset first loss weight contains more semantic information, the total model loss obtained by combining the total encoding loss and total decoding loss also contains semantic information. Therefore, the parameter of the to-be-trained model is updated based on the total model loss until the total model loss converges, which can enable the trained model to obtain more semantic information, thereby improving an accuracy of the model.

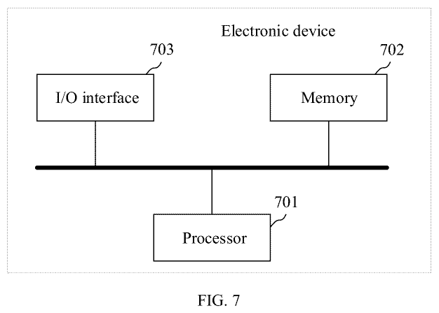

In a fourth aspect, an embodiment of the present disclosure provides an electronic device. FIG. 7 is a block diagram of an electronic device provided by the embodiment of the present disclosure. Referring to FIG. 7, the embodiment of the present disclosure provides an electronic device, including: at least one processor 701; at least one memory 702, and one or more I/O interfaces 703, connected between the processor 701 and the memory 702; where, the memory 702 stores one or more computer programs that can be executed by the at least one processor 701, and the one or more computer programs are executed by the at least one processor 701 to enable the at least one processor 701 to perform the model training method described above.

In some embodiments, the processor 701 is configured to perform feature extraction from a speech sample and obtain a speech feature, input the speech feature into an encoding network of a to-be-trained model for encoding processing, the encoding network includes cascaded encoding layers, and the encoding layer includes an intermediate encoding layer and an N-th encoding layer; decode an intermediate encoding feature to obtain an additional loss, where the intermediate encoding feature is an encoding feature output by the intermediate encoding layer; obtain an encoding loss based on an encoding feature output by the N-th encoding layer and an encoding label; and obtain a total encoding loss based on the additional loss, the encoding loss, and a preset first loss weight; input the encoding feature output by the N-th encoding layer into a decoding network of the to-be-trained model for decoding processing, and obtain a total decoding loss, where the decoding network includes cascaded M-layer decoding layers, M is an integer greater than or equal to 2, the decoding layer includes an intermediate decoding layer and an M-th decoding layer; and the intermediate decoding layer is the decoding layer in the decoding network except for the M-th decoding layer; obtain a total model loss based on the total encoding loss, the total decoding loss, and a preset second loss weight; update parameters in the encoding network and the decoding network based on the total model loss, train the to-be-trained model according to the updated parameters until the total model loss converges, and obtain a trained model.

In some embodiments, the processor 701 is further configured to decode the intermediate encoding feature to obtain an additional decoding feature; and obtain the additional loss based on the additional decoding feature and a preset additional decoding label.

In some embodiments, the intermediate encoding feature includes the intermediate encoding feature at one-third of the encoding network, and/or the intermediate encoding feature at two-thirds of the encoding network.

In some embodiments, the processor 701 is further configured to input the encoding feature output by the N-th encoding layer in the decoding network of the to-be-trained model for the decoding processing; obtain the intermediate loss based on the decoding feature output by the intermediate decoding layer and an intermediate decoding label; obtain a decoding loss based on the decoding feature output by the M-th decoding layer and a decoding label; and obtain the total decoding loss based on the intermediate loss, the decoding loss, and a preset third loss weight.

In some embodiments, the processor 701 is further configured to obtain a score matrix of a previous layer based on a query matrix and a key value matrix in a previous encoding layer; obtain a score matrix of a current layer based on a query matrix and a key value matrix in a current encoding layer; merge the score matrix of previous layer with the score matrix of current layer to obtain the encoding feature, and input the encoding feature into a next encoding layer.

In some embodiments, the processor 701 is further configured to input the speech feature into the to-be-trained model, perform a pre-train on the to-be-trained model, and obtain initial parameters for the encoding network and the decoding network.

In some embodiments, the processor 701 is further configured to update the parameters in the encoding network and the decoding network based on the total model loss and a regularization term during a parameter update phase.

In some embodiments, the processor 701 is also further configured to obtain the speech sample and segment the speech sample to obtain speech segments; and annotate the speech segment that belongs to noise and obtain a noise label.

The various modules in the above-mentioned electronic device can be fully or partially implemented through software, hardware and their combinations. The above modules can be embedded in a hardware form or independent of a processor in a computer device, or stored in a software form in a memory of the computer device, so that the processor can call and execute the corresponding operations of the above modules.

An embodiment of the present disclosure also provides a computer-readable storage medium on which a computer program is stored, where the computer program implements the above model training method when executed by a processor. And the computer-readable storage medium can be a volatile or non-volatile computer-readable storage medium.

An embodiment of the present disclosure also provides a computer program product, including computer-readable codes, or a non-volatile computer-readable storage medium carrying the computer-readable codes, when the computer-readable codes are executed in a processor of an electronic device, the processor in the electronic device executes the above model training method.

Those ordinary skilled in the art can understand that, all or some of steps, systems, and functional modules/units in apparatus in the disclosed methods can be implemented as software, firmware, hardware, and appropriate combinations thereof. In a hardware implementation, a division between functional modules/units mentioned in the above description does not necessarily correspond to the division of physical components. For example, one physical component can have multiple functions, or one function or step can be executed collaboratively by several physical components. Some or all physical components can be implemented as software executed by a processor such as a central processing unit, a digital signal processor, or a microprocessor, or implemented as hardware, or implemented as integrated circuits such as application specific integrated circuits. Such software can be distributed on a computer-readable storage media, which can include a computer storage medium (or non-temporary medium) and a communication medium (or temporary medium).

As is well known to those ordinary skilled in the art, the term computer storage medium includes volatile and non-volatile, removable and non-removable medium implemented in any method or technique for storing information (such as computer-readable program instructions, data structures, program modules, or other data). The computer storage media includes but is not limited to a random access memory (RAM), a read-only memory (ROM), an erasable programmable read-only memory (EPROM), a static random access memory (SRAM), a flash memory or other storage technologies, a portable compact disc read-only memory (CD-ROM), a digital versatile disc (DVD) or other optical disc storage, a magnetic cartridge, a magnetic tape, a magnetic disk storage or other magnetic storage devices, or any other medium that can be used to store desired information and can be accessed by a computer. In addition, it is well known to those skilled in the art that, the communication media typically includes the computer-readable program instruction, data structure, program module, or other data in a modulated data signal such as carriers or other transmission mechanisms, and may include any information delivery medium.

The computer-readable program instructions described here can be downloaded from the computer-readable storage media to various computing/processing devices, or downloaded to external computers or external storage devices through networks (such as the Internet, local area networks, wide area networks, and/or wireless networks). The network can include copper transmission cables, fiber optic transmission, wireless transmission, routers, firewalls, switches, gateway computers, and/or edge servers. A network adapter card or network interface in each computing/processing device receives the computer-readable program instructions from the network and forwards the computer-readable program instructions for storing on the computer-readable storage media in each computing/processing device.

The computer program instructions used to perform operations in the present disclosure may be assembly instructions, instruction set architecture (ISA) instructions, machine instructions, machine related instructions, microcode, firmware instructions, state setting data, or source or object code written in any combination of one or more programming languages, which includes object-oriented programming languages such as Smalltalk, C++, and conventional procedural programming languages such as “C” or similar programming languages. The computer readable program instructions can be executed entirely on the computer of a user, partially on the computer of user, as a standalone software package, partially on the computer of user and partially on a remote computer, or entirely on the remote computer or a server. In cases involving the remote computer, the remote computer can be connected to the computer of user through any type of network, including a local area network (LAN) or a wide area network (WAN), or can be connected to the external computer (such as using an internet service provider to connect through the Internet). In some embodiments, electronic circuits (such as programmable logic circuits, field programmable gate arrays (FPGA), or programmable logic arrays (PLA)) can be customized by utilizing state information of the computer readable program instruction, and the electronic circuit can execute the computer-readable program instructions to achieve various aspects of the present disclosure.

The computer program product described here can be specifically implemented through hardware, software, or a combination thereof. In an optional embodiment, the computer program product is embodied as the computer storage medium; while in another optional embodiment, the computer program product is embodied as a software product, such as a software development kit (SDK) and the like.

Here, various aspects of the present disclosure are described with reference to flowcharts and/or block diagrams in methods, apparatus (systems), and computer program products according to embodiments of the present disclosure. It should be understood that each box in the flowchart and/or block diagram, as well as combinations of boxes in the flowchart and/or block diagram, can be implemented by computer-readable program instructions.

These computer-readable program instructions can be provided to a processor of a general-purpose computer, a specialized computer, or other programmable data processing apparatus to produce a machine that, when these instructions are executed by the processor of the computer or other programmable data processing apparatus, produces an apparatus that implements functions/actions specified in one or more blocks in the flowchart and/or block diagram. These computer-readable program instructions can also be stored in the computer-readable storage medium, and these instructions enable the computer, programmable data processing apparatus, and/or other equipment to operate in a specific manner. Therefore, the computer-readable medium storing the instructions includes a product that includes instructions for implementing various aspects of the functions/actions specified in one or more blocks in the flowchart and/or block diagram.

The computer readable program instructions can also be loaded onto the computer, other programmable data processing apparatus, or other equipment to perform a series of operational steps on the computer, other programmable data processing apparatus, or other equipment, in order to generate a computer implemented process, thereby enabling the instructions executed on the computer, other programmable data processing apparatus, or other equipment to implement the functions/actions specified in one or more blocks in the flowchart and/or block diagram.

The flowchart and block diagram in accompanying drawings show architectures, functions, and operations that may be implemented by the system, method, and computer program product according to multiple embodiments of the present disclosure. In this regard, each block in the flowchart or block diagram can represent one module, program segment, or part of an instruction, and the module, program segment or part of instruction includes one or more executable instructions for implementing specified logical functions. In some alternative implementations, the functions marked in the block can also occur in a different order than those marked in the accompanying drawings. For example, two consecutive boxes can actually be executed in parallel, and sometimes they can also be executed in reverse order, which depends on the functions involved. It should also be noted that, each block in the block diagram and/or flowchart, as well as combinations of blocks in the block diagram and/or flowchart, can be implemented using a dedicated hardware-based system that perform specified functions or actions, or can be implemented using a combination of dedicated hardware and computer instructions.

This article has disclosed example embodiments, and although specific terms are used, they are only for and should be interpreted in a general explanatory sense and are not intended for limiting purposes. In some instances, it is evident to those skilled in the art that features, characteristics, and/or elements described in combination with specific embodiments may be used alone or in combination with the feature, characteristic, and/or element described in combination with other embodiments, unless otherwise specified. Therefore, those skilled in the art will understand that, various changes in forms and details can be made without departing from a scope of the present disclosure as set forth in the appended claims.

What is claimed is:

1. A model training method, comprising:
performing feature extraction from a speech sample to obtain a speech feature;
inputting the speech feature into an encoding network in a model, wherein the encoding network comprises cascaded encoding layers, and the encoding layer comprises a first encoding layer and a second encoding layer;
decoding a first encoding feature to obtain an additional loss, wherein the first encoding feature is an encoding feature output by the first encoding layer;
obtaining an encoding loss based on a second encoding feature output by the second encoding layer and an encoding label;
obtaining a total encoding loss based on the additional loss, the encoding loss, and a preset first loss weight;
inputting the second encoding feature output by the second encoding layer into a decoding network for decoding processing to obtain a total decoding loss;
obtaining a total model loss based on the total encoding loss, the total decoding loss, and a preset second loss weight;
updating parameters in the encoding network and the decoding network based on the total model loss, and training the model according to the updated parameters, until the total model loss converges, obtaining a trained model.

2. The method according to claim 1, wherein the decoding the first encoding feature to obtain the additional loss comprises:
decoding the first encoding feature by using an additional decoding network to obtain an additional decoding feature;
obtaining the additional loss based on the additional decoding feature and a preset additional decoding label.

3. The method according to claim 1, wherein the first encoding feature comprises the first feature at one-third of the encoding network, and/or the first encoding feature at two-thirds of the encoding network.

4. The method according to claim 1, wherein the inputting the second encoding feature output by the second encoding layer into the decoding network to obtain the total decoding loss, comprises:
obtaining a first loss based on a decoding feature output by a first decoding layer and a first decoding label, wherein the decoding network comprises the first decoding layer and a second decoding layer;
obtaining a decoding loss based on the decoding feature output by the M-th decoding layer and a decoding label;
obtaining the total decoding loss based on the first loss, the decoding loss, and a preset third loss weight.

5. The method according to claim 1, wherein the following steps are performed in the encoding network:
obtaining a score matrix of a previous layer based on a query matrix and a key value matrix in a previous encoding layer;
obtaining a score matrix of a current layer based on a query matrix and a key value matrix in a current encoding layer;
merging the score matrix of the previous layer and the score matrix of the current layer to obtain the encoding feature, and inputting the encoding feature into a next encoding layer.

6. The method according to claim 1, wherein before the decoding the first encoding feature to obtain the additional loss, the method further comprises:
obtaining a first total encoding loss based on the second encoding feature output by the second encoding layer and the encoding label;
inputting the second encoding feature output by the second encoding layer into the decoding network of the model to obtain a first total decoding loss;
obtaining a first total model loss based on the first total encoding loss, the first total decoding loss and a preset second loss weight;
updating the parameters in the encoding network and the decoding network based on the first total model loss, training the model until a preset condition is reached, and obtaining a pre-trained model;
using the parameters of the pre-trained model as initial parameters for the encoding network and the decoding network.

7. The method according to claim 1, wherein the updating the parameters in the encoding network and the decoding network based on the total model loss comprises:
updating the parameters in the encoding network and the decoding network based on the total model loss and a regularization term during a parameter update phase.

8. The method according to claim 1, wherein before the performing the feature extraction from the speech sample to obtain the speech feature, the method comprises:
obtaining the speech sample and segmenting the speech sample to obtain speech segments;
annotating the speech segment that belongs to noise and obtaining a noise label.

9. A speech recognition model, wherein the speech recognition model is a model obtained by means of the model training method according to claim 1.

10. A model training apparatus, comprising:
at least one processor; and,
a memory communicatively connected with the at least one processor, wherein,
the memory stores one or more computer programs executed by the at least one processor, the one or more computer programs are executed by the at least one processor to enable the at least one processor to:
perform feature extraction from a speech sample to obtain a speech feature;
input the speech feature into an encoding network in a model, wherein the encoding network comprises cascaded encoding layers, and the encoding layer comprises a first encoding layer and a second encoding layer;
decode a first encoding feature to obtain an additional loss, wherein the first encoding feature is an encoding feature output by the first encoding layer;
obtain an encoding loss based on a second encoding feature output by the second encoding layer and an encoding label, and obtain a total encoding loss based on the additional loss, the encoding loss, and a preset first loss weight;
input the second encoding feature output by the second encoding layer into a decoding network for decoding processing to obtain a total decoding loss;
obtain a total model loss based on the total encoding loss, the total decoding loss, and a preset second loss weight;
update parameters in the encoding network and the decoding network based on the total model loss, and train the model according to the updated parameters until the total model loss converges, obtain a trained model.

11. The apparatus according to claim 10, wherein the at least one processor is further enabled to:
decode the first encoding feature by using an additional decoding network to obtain an additional decoding feature;
obtain the additional loss based on the additional decoding feature and a preset additional decoding label.

12. The apparatus according to claim 10, wherein the first encoding feature comprises the first encoding feature at one-third of the encoding network, and/or the first encoding feature at two-thirds of the encoding network.

13. The apparatus according to claim 10, wherein the at least one processor is further enabled to:
obtain a first loss based on a first decoding feature output by a first decoding layer and a first decoding label, wherein the decoding network comprises the first decoding layer and a second decoding layer;
obtain a decoding loss based on the decoding feature output by the M-th decoding layer and a decoding label;
obtain the total decoding loss based on the first loss, the decoding loss, and a preset third loss weight.

14. The apparatus according to claim 10, wherein the at least one processor is further enabled to perform the following steps in the encoding network:
obtaining a score matrix of a previous layer based on a query matrix and a key value matrix in a previous encoding layer;
obtaining a score matrix of a current layer based on a query matrix and a key value matrix in a current encoding layer;
merging the score matrix of the previous layer and the score matrix of the current layer to obtain the encoding feature, and inputting the encoding feature into a next encoding layer.

15. The apparatus according to claim 10, wherein the at least one processor is further enabled to:
obtain a first total encoding loss based on the second encoding feature output by the second encoding layer and the encoding label;
input the second encoding feature output by the second encoding layer into the decoding network of the model to obtain a first total decoding loss;
obtain a first total model loss based on the first total encoding loss, the first total decoding loss and a preset second loss weight;
update the parameters in the encoding network and the decoding network based on the first total model loss, train the model until a preset condition is reached, and obtain a pre-trained model;
use the parameters of the pre-trained model as initial parameters for the encoding network and the decoding network.

16. The apparatus according to claim 10, wherein the at least one processor is further enabled to:
update the parameters in the encoding network and the decoding network based on the total model loss and a regularization term during a parameter update phase.

17. The apparatus according to claim 10, wherein the at least one processor is further enabled to:
obtain the speech sample and segment the speech sample to obtain speech segments;
annotate the speech segment that belongs to noise and obtain a noise label.

18. A non-transitory computer-readable storage medium storing a computer program thereon, wherein the computer program, when executed by a processor, implements the following steps:
performing feature extraction from a speech sample to obtain a speech feature;
inputting the speech feature into an encoding network in a model, wherein the encoding network comprises cascaded encoding layers, and the encoding layer comprises a first encoding layer and a second encoding layer;
decoding an first encoding feature to obtain an additional loss, wherein the first encoding feature is an encoding feature output by the first encoding layer;
obtaining an encoding loss based on an encoding feature output by the second encoding layer and an encoding label;
obtaining a total encoding loss based on the additional loss, the encoding loss, and a preset first loss weight;
inputting the encoding feature output by the second encoding layer into a decoding network for decoding processing to obtain a total decoding loss;
obtaining a total model loss based on the total encoding loss, the total decoding loss, and a preset second loss weight;
updating parameters in the encoding network and the decoding network based on the total model loss, and training the model according to the updated parameters, until the total model loss converges, obtaining a trained model.

19. The non-transitory computer-readable storage medium according to claim 18, wherein the decoding the first encoding feature to obtain the additional loss comprises:
decoding the first encoding feature by using an additional decoding network to obtain an additional decoding feature;
obtaining the additional loss based on the additional decoding feature and a preset additional decoding label.

20. The non-transitory computer-readable storage medium according to claim 18, wherein the first encoding feature comprises the first encoding feature at one-third of the encoding network, and/or the first encoding feature at two-thirds of the encoding network.
